(19) United States
(12) Patent Application Publication
(10) Pub. No.: US 2026/0145386 A1
(43) Pub. Date: May 28, 2026

(54) Building Platform System for Additive Manufacturing

(71) Applicant: ADDITIVESTREAM4D GMBH, Berlin (DE)

(72) Inventors: Simon Frederik Feicks, Berlin (DE); Clemens Cosmo Maskowski, Berlin (DE)

(21) Appl. No.: 19/121,219

(22) PCT Filed: Nov. 1, 2023
(86) PCT No.: PCT/DE2023/150027

§ 371 Date: Apr. 15, 2025

(30) Foreign Application Priority Data
Nov. 3, 2022 (DE) 10 2022 129 035.2
Nov. 3, 2022 (DE) 10 2022 129 042.5

(51) Int. Cl. B29C 64/245; B29C 64/295; B33Y 30/00

(52) U.S. Cl. CPC B29C 64/245; B29C 64/295; B33Y 30/00; B29K 2905/10

(57) ABSTRACT

The invention relates to a building platform system for additive manufacturing that can be flexibly installed in different additive manufacturing devices. The building platform system comprises a building platform (2) serving as a component carrier, a plate-shaped machine interface unit (1) that is designed as a base for the building platform (2), which can be releasably fastened in a fixed position on it, as well as several base fastening units for the releasable fastening of the machine interface unit (1) in the additive manufacturing device. The machine interface unit (1) additionally has a zero-point clamping system (6) and several fitting bores (9) on the side facing the building platform (2). The building platform system is suitable both for hybrid additive manufacturing of new parts and for the repair of conventionally or additively manufactured components.

### CROSS REFERENCE TO RELATED APPLICATIONS

This application is the U.S. national stage of International Application No. PCT/DE2023/150027, filed on 2023 Nov. 1. The international application claims the priority of DE 102022129035.2 filed on 2022 Nov. 3 and the priority of DE 102022129042.5 filed on 2022 Nov. 3; all applications are incorporated by reference herein in their entirety.

### BACKGROUND

The invention relates to a building platform system for additive manufacturing, which can be flexibly installed in various additive manufacturing devices. The building platform system is suitable for hybrid additive manufacturing of new parts as well as for the repair of conventionally or additively manufactured components.

Additive manufacturing processes, such as powder bed-based selective laser melting (Laser Powder Bed Fusion, LPBF), are primarily designed for the near-net-shape production of complete new parts: based on a virtual 3D component model, material is consolidated layer by layer on a building platform of the additive manufacturing device until the component body specified by the 3D model is completed. The starting material for the production of high-quality metallic components using powder bed-based selective laser melting is usually a narrowly specified and therefore cost-intensive metal powder, which, however, is only melted to a fraction to form the additively manufactured component. A large proportion of the powder serves only as filler and support material.

The additive manufacturing of metallic components using selective laser melting is still sometimes unprofitable compared to traditional manufacturing processes in many industries due to long production times, insufficiently known material data and also due to the high powder consumption. However, additive manufacturing has already established itself in the production of high-priced, geometrically complex or customized components, especially components from the aviation industry or medical technology.

In addition to the production of new parts, additive manufacturing also offers the possibility of repairing components close to their final shape. In the aircraft engine industry, for example, parts of blades or vanes are repaired by additively building up the worn material.

Additive manufacturing, in which material is applied to existing components or component elements close to the final shape, is also referred to as hybrid (additive) manufacturing. In contrast to complete manufacturing, hybrid manufacturing requires precise positioning of the components within the manufacturing device or exact knowledge of the component position on the building platform.

The building platform is generally the part of the additive manufacturing device on which the components are manufactured. In the context of this disclosure, the entirety of all device parts of the additive manufacturing device that support the components to be manufactured is referred to as the building platform system. The building platform in the narrower sense is understood to be the device element, usually in the form of a plate, on which the additively manufactured components are directly attached.

It is known, for example from US 2019/0366491 A1, WO 2020/159432 A1, DE 10 2021 105 918 A1, or DE 10 2017 219 333 A1, to fix worn components that are to be repaired by additive manufacturing with the help of an auxiliary or holding plate, i.e. a component carrier. In the sense mentioned above, the holding plate, fitted with the components, forms the building platform as part of the building platform system and is attached to the permanently installed machine components of the additive manufacturing device, i.e. for example to the usually height-adjustable work plate of the manufacturing device. In order to determine the exact component position for subsequent additive manufacturing, the holding plate with the components fastened onto it is measured-usually outside the actual additive manufacturing device-in relation to a reference marking present on the holding plate. Once the reference marking is fixed or captured in position within the manufacturing device, it then becomes possible to precisely control the component coordinates and apply material accurately during the additive manufacturing process

DE 10 2017 115 989 A1 discloses a building platform system for additive manufacturing, wherein the building platform system has an upper part as a building platform and a lower part as a base for the building platform, and in which the upper part and lower part are releasably attached to one another by screw connections. A building platform system that likewise consists of a building platform and plate-shaped base elements arranged beneath is described in DE 10 2019 130 676 A1.

DE 10 2013 014 036 A1 discloses a clamping device for holding workpieces or tools, featuring a workpiece carrier with clamping pins and a clamping lower part with clamping bushings. A device for the positionally accurate clamping of a workpiece, in which a substructure with a workpiece carrier can be connected by interlocking clamping bushings and clamping pins, is also known from DE 43 07 342 A1.

Attaching such a holding plate to the machine components of the additive manufacturing device generally requires a relatively high setup effort. In addition, the holding plate, which is often customized to a specific additive manufacturing device, is more difficult to use as a component carrier on other additive manufacturing devices.

### SUMMARY

The invention relates to a building platform system for additive manufacturing that can be flexibly installed in different additive manufacturing devices. The building platform system comprises a building platform (2) serving as a component carrier, a plate-shaped machine interface unit (1) that is designed as a base for the building platform (2), which can be releasably fastened in a fixed position on it, as well as several base fastening units for the releasable fastening of the machine interface unit (1) in the additive manufacturing device. The machine interface unit (1) additionally has a zero-point clamping system (6) and several fitting bores (9) on the side facing the building platform (2). The building platform system is suitable both for hybrid additive manufacturing of new parts and for the repair of conventionally or additively manufactured components.

### DETAILED DESCRIPTION

The object of the invention is to provide a building platform system that can be used flexibly on different additive manufacturing devices with minimal setup effort and that enables the precise positioning of a building platform designed as a component carrier or enables the precise approach to already existing component structures on a building platform-even in hybrid additive manufacturing.

This object is achieved by a building platform system having the features of claim 1. Further embodiments of the invention are described in claims 2 to 13.

According to the invention, the building platform system provided for installation in an additive manufacturing device comprises a building platform serving as a component carrier, a plate-shaped machine interface unit that is designed as a base for the building platform, which can be releasably fastened in position on top of the machine interface unit, as well as several base fastening units for the releasable fastening of the machine interface unit in the additive manufacturing device.

The plate-shaped machine interface unit and the likewise typically plate-shaped building platform preferably each have a rectangular basic shape of their respective plate surfaces.

In order to form a screw connection with the additive manufacturing device, i.e., to releasably attach the machine interface unit in the additive manufacturing device, each of the base fastening units has a connecting adapter and a base screw that can be form-fittingly anchored in a screw head recess provide laterally into the connecting adapter. This means that for installation, the screw head of the base screw, in relation to the screw's longitudinal direction, is laterally inserted with the screw head into the screw head recess of the connecting adapter. Furthermore, the machine interface unit has an adapter recess, which is allocated to each of the connecting adapters, is shaped to match it, and is open toward the building platform. Into this adapter recess, the connecting adapter, as an anchor on the screw head of the base screw, can be inserted in a manner preventing rotation. At the bottom of the adapter recess, there is a through-hole through which the base screw can be passed to the additive manufacturing device. Finally, each of the connecting adapters has a threaded bore that, when the base screw is properly mounted in the connecting adapter, is coaxially aligned with the base screw anchored in the connecting adapter and is located on the side of the screw head of the base screw opposite the thread. In other words, the threaded bore is in line with the base screw above its screw head. Preferably, the building platform system has four base fastening units, which, in the case of the machine interface unit being designed with a rectangular base area, are arranged in each corner region, for example.

According to the invention, the machine interface unit also has a zero-point clamping system for the releasable attachment of the building platform to the machine interface unit, wherein the zero-point clamping system preferably being arranged centrally in relation to the plate-shaped design of the machine interface unit.

Finally, on its side facing the building platform, the machine interface unit has several fitting bores for the insertion of dowel pins. In relation to the plate-shaped design of the machine interface unit, the fitting bores are preferably arranged around the zero-point clamping system.

One advantage of the building platform system according to the invention is that the calibration required for high manufacturing accuracy need only be carried out once on the machine interface unit after installation in the additive manufacturing device. By using the zero-point clamping system, the base fastening units, and/or the dowel pin connections in the fitting bores, the building platform that is attached to the machine interface unit is precisely aligned with the machine interface unit, so that an additional calibration of the building platform can generally be omitted.

The machine interface unit can be adapted by parameterization, in particular the positioning of the adapter recesses, to different additive manufacturing devices.

The building platform system according to the invention is also characterized by high flexibility with regard to the building platform that can be attached. For example, a building platform designed as a standard building platform or as a quick-change building platform can be mounted with repeatable accuracy on or onto the machine interface unit.

Because of improved manufacturing accuracy in additive manufacturing, the building platform system is particularly suitable for reducing costs in hybrid additive new-part manufacturing, in the repair of additively designed components, in the repair of conventionally manufactured components, or in the repair of additively manufactured components after so-called “failed build jobs”, i.e. for correcting a defective additive build.

It is provided that the building platform designed as a standard building platform can be releasably fastened in a positionally fixed manner to the machine interface unit by means of building platform screws inserted into the threaded bores of the anchored connecting adapters. In other words, the standard building platform has a specified number of bores, for example in each corner area in the case of a rectangular building platform, through which the building platform screws are inserted and subsequently screwed into the threaded bore of the connecting adapters. Consequently, the standard building platform is attached to the machine interface unit by means of the building platform screws, which are arranged coaxially with the base screws. The building platform is thus fastened in the additive manufacturing device via the connecting adapters, so that there are no constraints due to direct screw connections with the machine interface unit. The term “standard building platform” is used here for this embodiment of the building platform because it is particularly provided for the standard process of building up a complete part directly on the building platform.

In addition to the possibility described above for attaching the standard building platform to the machine interface unit, alternative attachment embodiments are also possible, for example by means of screw connections in other positions or by magnetic locking of the standard building platform onto the machine interface unit.

In the embodiment in which the building platform is designed as a quick-change building platform, it can be releasably fastened in position on the machine interface unit by means of the zero-point clamping system. In the present text, the term “quick-change building platform” is understood to mean a building platform that has, on its bottom side (the side opposite the build side for additive manufacturing), a mating element that can be accommodated by the zero-point clamping system. This quick-change building platform embodiment allows especially fast exchange of the building platform. The building platform system with a quick-change building platform is particularly intended for hybrid additive manufacturing, where the advantage in particular is that only the machine interface unit needs to be calibrated.

For improved positional fixation of the building platform relative to the machine interface unit, the building platform may have fitting bores corresponding to the fitting bores of the machine interface unit. For this purpose, the building platform system further comprises a number of dowel pins that are inserted into the corresponding fitting bores when assembled. This pinning provides improved positional accuracy in terms of the angular rotation of the building platform and the machine interface unit in the plane of the plates. Particularly high accuracy is achieved if the fitting bores of the building platform and the machine interface unit—when mounted on top of each other—are produced or drilled together.

According to an embodiment of the building platform system that can be used in particular for temperature control of the building platform, the machine interface unit has heat-conducting bodies, also referred to as heat-conducting inlets, which are integrated into the machine interface unit or form part of it. For this purpose, the plate-shaped machine interface unit has recesses running through it in its thickness direction that are form-fitted with the heat-conducting bodies. Especially in standard additive manufacturing, i.e., in the additive production of new parts on a standard building platform, the building platform is regularly heated, for example to temperatures in the range from 80° C. to 200° C. Heating is usually performed from underneath the building platform. In order to ensure the mostly loss-free heat conduction even when the machine interface unit is in place, the heat-conducting bodies are provided. These heat-conducting bodies are preferably made of copper or a copper alloy.

It can also be provided that the machine interface unit itself has a heat source, for example an integrated heating unit.

Furthermore, the machine interface unit and/or the building platform can each have an RFID transponder for contactless data storage and data query of identification data, calibration data and/or manufacturing data. The abbreviation RFID (radio-frequency identification) describes a well-known technology for the automatic and contactless identification and localization of objects using radio waves. An RFID system usually includes an RFID transponder and a reader.

In an embodiment of the building platform system with a quick-change building platform, whose zero-point clamping system is pneumatically operated by compressed air, a shut-off valve connected to a shut-off valve control unit to interrupt the supply of compressed air could be provided. This embodiment is provided in particular to prevent unauthorized—for example unlicensed—use of the building platform system. For this purpose, the shut-off valve control unit can, for example, be coupled to an RFID transponder, by means of which the shut-off valve can be released or blocked by the shut-off valve control unit.

For calibrating the machine interface unit that is releasably fastened in the additive manufacturing device, the building platform system can further comprise a calibration set. The calibration set includes a calibration plate, several calibration dowel pins, and preferably a hemispherical element that can be releasably locked to the zero-point clamping system. The calibration plate, which can be releasably attached for calibration on the side of the machine interface unit intended for fastening the building platform, largely covers this side of the machine interface unit. It has recesses for fastening the calibration plate, recesses for the calibration dowel pins, and a recess for the hemispherical element in the area of the zero-point clamping system. The calibration dowel pins, which can be releasably inserted into the fitting bores of the machine interface unit for calibration, each have a reference marking, also referred to as a reference point. When locked in the zero-point clamping system, the hemispherical element's reference marking is located in the center of the zero-point clamping system. The calibration dowel pins usually have the reference marking on one of their end faces; the calibration set preferably includes up to four of the calibration dowel pins.

The components of the calibration set are also preferably designed as described in German patent application DE 10 2022 129 042.5. In this regard, reference is made to the German patent application with application number DE 10 2022 129 042.5, the content of which is hereby incorporated into this patent application.

According to an alternative embodiment, the calibration set can include a calibration platform, formed correspondingly to the building platform—particularly to the quick-change building platform—for releasable fastening onto the machine interface unit, again a calibration plate and several calibration pins. The calibration pins each have a reference marking, usually at end-face. However, they are permanently installed on the side of the calibration platform facing away from the machine interface unit, so that they protrude from the surface plane of the calibration platform. The calibration set preferably includes up to five permanently installed calibration pins (in particular one arranged in the center and four arranged in the corner areas). The calibration pins can be implemented in the form of the calibration dowel pins described above, which are securely inserted into the calibration platform, or can be integrally joined to the calibration platform, for example in the form of a cylinder milled from solid. Preferably, the calibration platform—similar to the quick-change building platform—can be releasably fastened in position on the machine interface unit by means of the zero-point clamping system. The calibration platform in this case has the mating element that can be accommodated by the zero-point clamping system. The calibration plate, which has a similar design to that previously described, again has recesses for fastening the calibration plate and recesses for the calibration pins. The calibration plate according to this embodiment of the calibration set, which can be releasably attached to the side of the calibration platform fitted with the calibration pins for calibration, largely covers this side of the calibration platform. Preferably, the calibration plate and/or the calibration pins are dimensioned such that, when the calibration plate is attached to the calibration platform, the end faces of the calibration pins that carry the reference markings lie in the surface plane of the calibration plate, i.e. form a single plane with the surface of the calibration plate.

According to a further embodiment, the building platform system includes at least one component holder that can be pivotably installed on the building platform, i.e., the component can be brought into a desired angular position relative to the horizontal alignment by pivoting or turning it. The component holder can be designed to pivot either continuously or in fixed increments. In the case of a continuously pivotable design, for example, the component holder has a base that can be locked in the building platform and a component holding unit that is rotatably mounted on this base. In a stepped-pivot design, the component holder can be designed in such a way that it can be locked onto the building platform in different orientations or angular positions. In general, several of these component holders are installed on the building platform.

It can further be provided that the building platform system includes at least one component holder that can be locked onto the building platform and that contains a heating unit or heating element, for example a cartridge heater. This enables close-to-the-component temperature control during additive manufacturing. In powder bed-based selective laser melting, for example, if a crack-sensitive material is processed, it is necessary to preheat the components to avoid crack formation. By using the component holder with the integrated heating element, this preheating—if necessary also individually for each component—can be carried out, i.e., the component is preheated to the desired processing temperature by means of the heating element. In general, several of these heatable component holders are installed on the building platform.

### BRIEF DESCRIPTION OF THE DRAWINGS

The invention is explained in more detail below using exemplary embodiments and with reference to the schematic drawings, in which identical or similar features are provided with identical reference numerals. It shows:

FIG. 1: a first embodiment of the building platform system in a perspective view,

FIG. 2: the first embodiment of the building platform system in an exploded view,

FIG. 3: a second embodiment of the building platform system in a perspective view,

FIG. 4: the fastening of the building platform system in a perspective view,

FIG. 5: a building platform system equipped with components in a perspective view,

FIG. 6: various embodiments of building platforms in a perspective view,

FIG. 7: an embodiment of the building platform with marking bores in a perspective view,

FIG. 8: an embodiment of the machine interface unit with heat-conducting bodies in a perspective view,

FIG. 9: the embodiment of the machine interface unit according to FIG. 8 in section A-A,

FIG. 10: a first embodiment of the machine interface unit with a calibration set in a perspective view,

FIG. 11: the embodiment of the machine interface unit according to FIG. 10 in section B-B,

FIG. 12: a calibration dowel pin in a perspective view,

FIG. 13: a second embodiment of the machine interface unit with a calibration set in a perspective view,

FIG. 14: the second embodiment of the machine interface unit with a calibration set in an exploded view,

FIG. 15: an embodiment of the machine interface unit with a shut-off valve in a sectional view, and

FIG. 16: a pivotable component holder installed on the building platform.

### DETAILED DESCRIPTION OF THE PREFERRED EMBODIMENTS

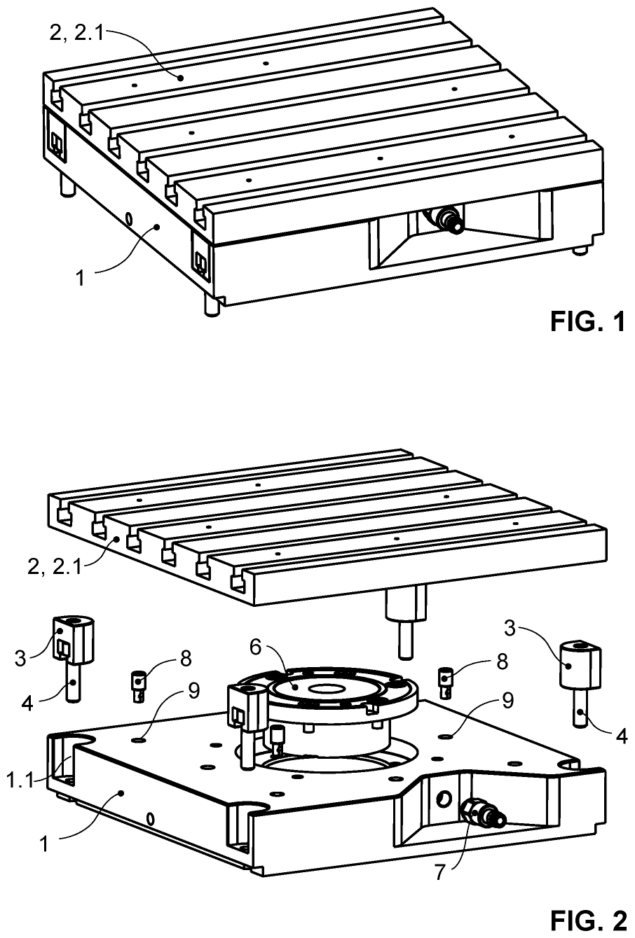

The first embodiment of the building platform system according to FIG. 1 and FIG. 2 comprises the machine interface unit 1 and the building platform 2 attached to it, which is designed as a quick-change building platform 2.1. The centrally arranged, pneumatic zero-point clamping system 6, which is supplied with compressed air via the compressed-air connection 7, serves to fasten the quick-change building platform 2.1 in place. The quick-change building platform 2.1, which is designed in particular for hybrid additive manufacturing, has several parallel T-slots or T-guides for attaching components that are to be processed additively.

The positional fastening of the building platform 2 on the machine interface unit 1 is achieved, on the one hand, by means of the zero-point clamping system 6 and, on the other hand, by means of the dowel pins 8, which are fitted into the fitting bores 9 in the machine interface unit 1 and simultaneously into corresponding (not designated) fitting bores in the building platform 2. The fitting bores 9, which are located outside the central zero-point clamping system 6, particularly improve the angular accuracy of the building platform 2 relative to the machine interface unit 1.

In order to fasten the machine interface unit 1 in the (not shown) additive manufacturing device, the machine interface unit 1 is screwed onto a flat base surface of the manufacturing device by means of the base screws 4. The base screws 4 are held in a form-fitting manner on the screw-head side in the connecting adapter 3. Each of the base screws 4 and the associated connecting adapter 3 together form one of the base fastening units. The connecting adapter 3 with the inserted base screw 4 is inserted into the adapter recess 1.1 of the machine interface unit 1, which is shaped to fit the connecting adapter 3, wherein the connecting adapter 3 largely fills the adapter recess 1.1.

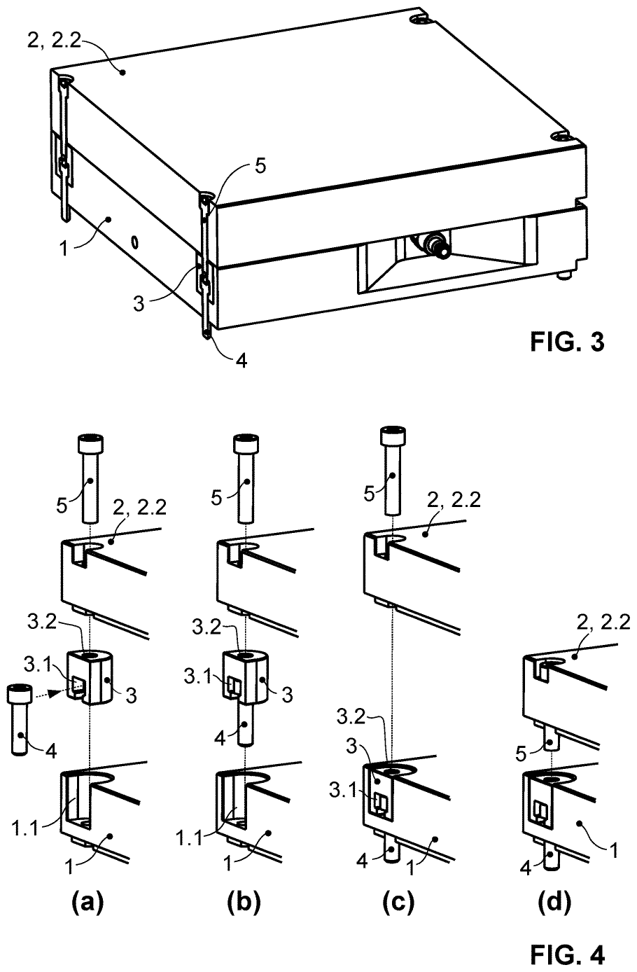

According to a second embodiment of the building platform system shown in FIG. 3, in addition to the machine interface unit 1, the system has a building platform 2 designed as a standard building platform 2.2. The standard building platform 2.2 is intended for conventional additive manufacturing, i.e., the components are built additively directly on the standard building platform 2.2. In contrast to the quick-change building platform 2.1 shown in FIG. 1, the standard building platform 2.2 is fastened to the machine interface unit 1 by means of the building platform screws 5.

The machine interface unit 1, in turn, is anchored in the (not shown) additive manufacturing device by means of the connecting adapters 3 and the base screws 4 inserted therein. For the subsequent attachment of the building platform 2, the building platform screws 5 assembled coaxially above the base screws 4 are screwed into the connecting adapter 3, which is securely inserted in the machine interface unit 1.

The fastening of the machine interface unit 1 in the additive manufacturing device by means of one of the base fastening units and the fastening of the building platform 2 designed as a standard building platform 2.2 by means of one of the building platform screws 5 are shown in detail in the illustrations (a) to (d) of FIG. 4.

FIG. 4(a) shows the connecting adapter 3 with its screw head recess 3.1 and its threaded bore 3.2. The base screw 4 is inserted laterally with its screw head into the screw head recess 3.1, which is shaped to fit the screw head (see arrow illustration). When the base screw 4 is inserted, the threaded bore 3.2 is located above the screw head of the base screw 4 and is coaxially aligned with it. After the base screw 4 has been inserted into the screw head recess 3.1, the screw head is—as shown in FIG. 4(b)—fastened in a form-fitting manner. The connecting adapter 3 is—see FIG. 4(c)—inserted together with the inserted base screw 4 into the adapter recess 1.1 of the machine interface unit 1.

The base screw 4 can now be screwed into a (not shown) fitting internal thread or secured by means of a nut on the additive manufacturing device. The base screw 4 can be tightened using, for example, an Allen key (hex key) that is guided through the threaded bore 3.2.

After the machine interface unit 1 has been fastened in the additive manufacturing device, the building platform 2 is placed on the machine interface unit 1. The building platform screw 5 used for this purpose is aligned coaxially to the base screw 4 or to the threaded hole 3.2 in the connection adapter 3 (see FIG. 4(a) to (c)). The building platform screw 5 engages, as shown in FIG. 4(d), into the internal thread of the threaded hole 3.2 of the connection adapter 3 anchored by the base screw 4 and, after tightening the building platform screw 5, fixes the build platform 2 on the machine interface unit 1.

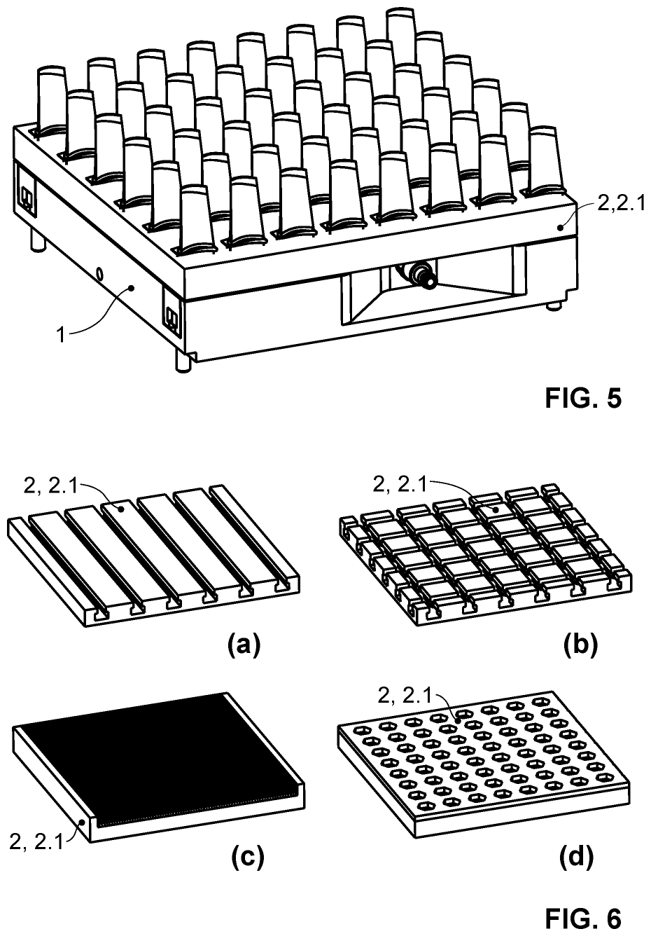

Another embodiment of the building platform system with the machine interface unit 1 and a building platform 2 designed as a quick-change building platform 2.1 for hybrid additive manufacturing is shown in FIG. 5. In FIG. 5, the building platform 2 serves as a component carrier for 48 components to be processed additively, shown here as an example in the form of turbine blades for aircraft engines whose worn blade tips have been rebuilt by hybrid additive manufacturing.

In order to hold components during additive manufacturing, the building platform 2 can be designed in various ways. FIG. 6 shows some examples: in FIG. 6(a) a quick-change building platform 2.1 with parallel T-slots, in FIG. 6(b) a quick-change building platform 2.1 with intersecting parallel T-slots, known as X-slots, in FIG. 6(c) a quick-change building platform 2.1 with a magnetic inlay or connection, and in FIG. 6(d) a quick-change building platform 2.1 with hexagonal recesses or receptacles for components.

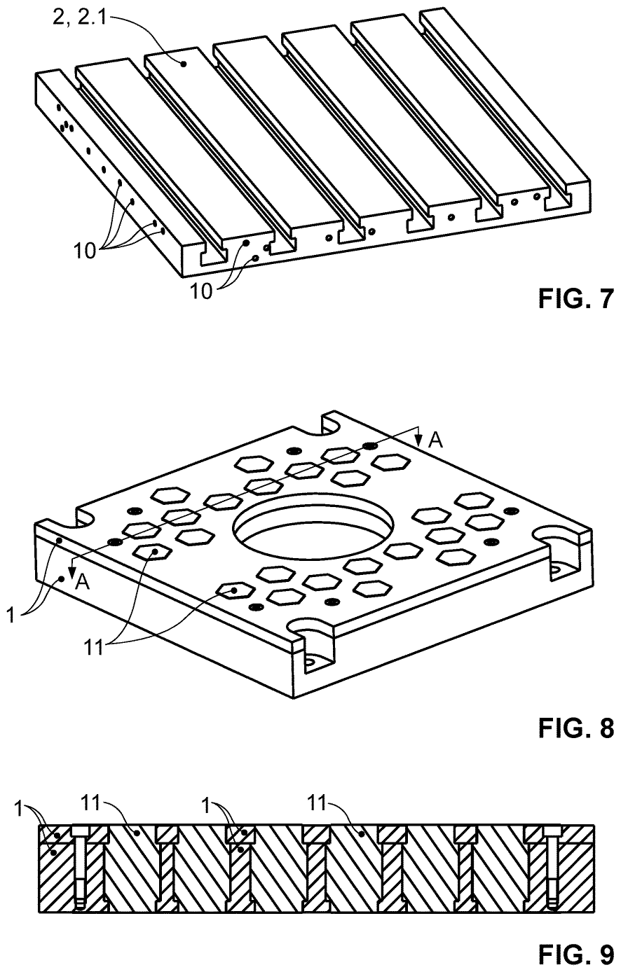

The design of the quick-change building platform 2.1 in FIG. 7 has, in addition to the T-slots for holding components, several laterally attached marking bores 10. The marking bores 10 serve for repeatedly accurate placement of reference markings that can be detected, for example, by means of structured light projection. The drilling pattern of the marking bores 10 can be applied in a customized manner and thus—similar to a 2D code—be used to identify the building platform 2.

The multi-part machine interface unit 1 according to FIG. 8 and FIG. 9 comprises a large number of continuous heat-conducting bodies 11 made of copper. By means of the heat-conducting bodies 11, which—after the building platform 2 is attached—are in direct contact with the building platform 2 at the top side of the machine interface unit 1 and in direct contact with the additive manufacturing device at the bottom side of the machine interface unit 1, heat can be effectively dissipated from the building platform 2 for cooling it during additive manufacturing or supplied for the targeted temperature control of the building platform 2. In the exemplary embodiment shown, the heat-conducting bodies 11 have a hexagonal cross-section, as can be seen in FIG. 8. As shown in FIG. 9, the heat-conducting bodies 11 are clamped between the two plate-shaped sub-elements of the machine interface unit 1, which are screwed together.

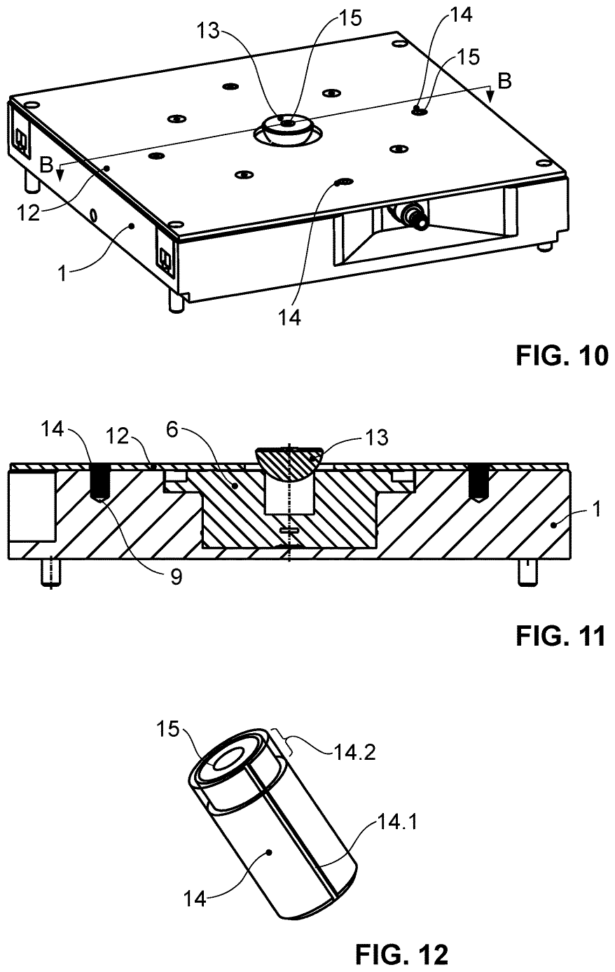

For calibrating the machine interface unit 1 that is fastened in the additive manufacturing device, the calibration set is used, which is shown in FIG. 10 and FIG. 11 next to the machine interface unit 1. For this purpose, the calibration plate 12, a burnished steel plate, is mounted on the machine interface unit 1. The hemispherical element 13 is locked onto the zero-point clamping system 6; four calibration dowel pins 14 are inserted into the fitting bores 9. As shown in FIG. 10, the hemispherical element 13 has a centrally attached reference marking 15. The calibration dowel pins 14 likewise each have a reference marking 15 on their end faces—see FIG. 10 and FIG. 12. For easy assembling and disassembling the calibration dowel pin 14, it has—as shown in FIG. 12—a longitudinal groove 14.1 to avoid excessive or insufficient press fit in the fitting bore 9, as well as a threaded section 14.2, i.e., an external thread, for easier removal (for example by means of a slide hammer with a corresponding adapter).

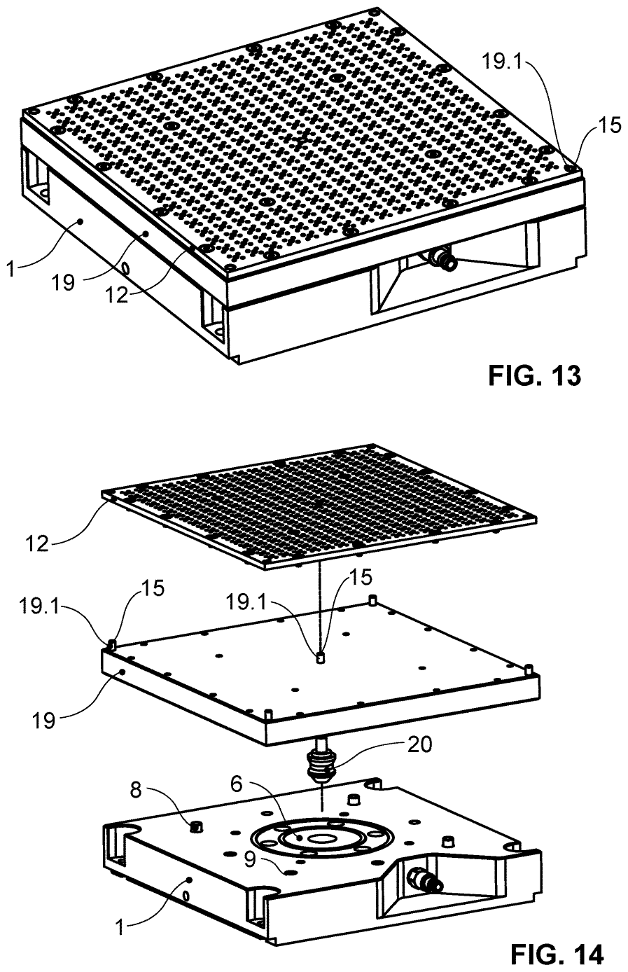

The second embodiment of the machine interface unit 1 with a calibration set shown in FIG. 13 and FIG. 14 includes, in addition to the calibration plate 12 and the machine interface unit 1, the calibration platform 19. As can be seen in FIG. 14, the calibration platform 19 can be locked onto the machine interface unit 1 by means of the zero-point clamping system 6. The mating element attached to the bottom side of the calibration platform 19 in the form of a clamping bolt 20 is used for fastening and positioning it in the zero-point clamping system 6. For precise alignment, the dowel pins 8 are placed in the fitting bores 9 (each designated only once in FIG. 14). In terms of this connection to the machine interface unit 1, the calibration platform 19 is designed in a manner comparable to the quick-change building platform 2.1 shown in FIG. 2.

The calibration pins 19.1, which are permanently installed on the calibration platform 19 and project upward, each have a reference marking 15 on their end faces (similar to the calibration dowel pins 14). In FIG. 13 and FIG. 14, for clarity reasons only selected calibration pins 19.1 or reference markings 15 are designated. The calibration plate 12 can be positioned and fastened on the calibration platform 19 by means of not designated screw connections. The height by which the calibration pins 19.1 protrude from the upper plate plane of the calibration platform 19 corresponds to the thickness of the calibration plate 12.

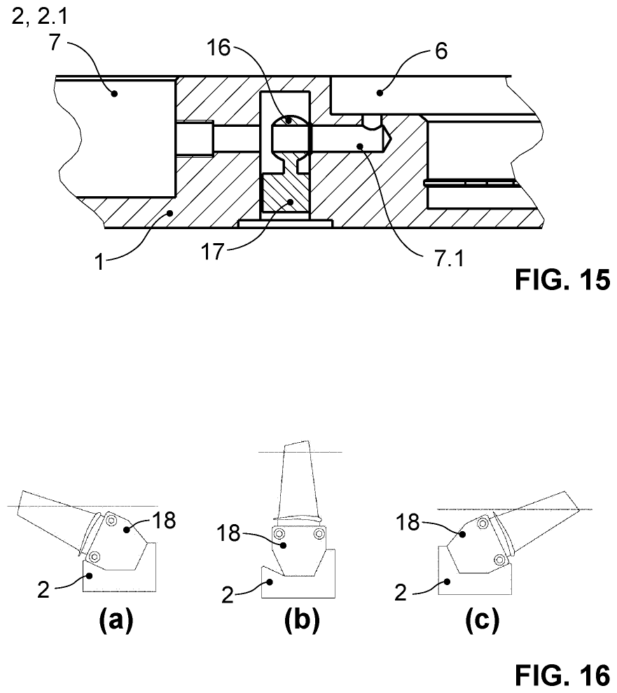

The sectional view of the machine interface unit 1 according to FIG. 15 shows the compressed-air connection 7, which is connected to the zero-point clamping system 6 via the compressed-air line 7.1. The shut-off valve 16 installed in the compressed-air line 7.1—by means of which the compressed-air supply from the compressed-air connection 7 to the zero-point clamping system 6 can be interrupted or released—is connected to the shut-off valve control unit 17. The shut-off valve control unit 17 can, for example, have an RFID transponder by means of which release is routinely triggered; otherwise, the zero-point clamping system 6 is locked. In this way, unauthorized use of the building platform system can be prevented.

In FIG. 16, a pivotable component holder 18 mounted on the building platform 2 is shown in three different positions. A component (not designated), here a rotor blade of an aircraft engine, is clamped in the component holder 18. The component holder 18 enables to align the component on the building platform 2 in relation to the structure to be built up so that the consolidation of the material to be built up during additive manufacturing can take place in a horizontally oriented plane. This horizontal processing plane is indicated in the three illustrations of FIG. 16 by the horizontal section line in the component. To set the most favorable manufacturing orientation in each case, the component holder 18—together with the component—is pivoted into the desired position. The individual illustrations in FIG. 16 show the optimal orientations for repairing different areas of the aircraft engine rotor blade clamped in the component holder, namely FIG. 16(a) the orientation optimized for repairing the leading edge, FIG. 16(b) the orientation optimized for repairing the blade tip, and FIG. 16(c) the orientation optimized for repairing the trailing edge.

### LIST OF REFERENCE NUMERALS

1 machine interface unit
1.1 adapter recess
2 building platform
2.1 quick-change building platform
2.2 standard building platform
3 connecting adapters
3.1 screw head recess
3.2 threaded bore
4 base screw
5 building platform screw
6 zero-point clamping system
7 compressed-air connection
7.1 compressed-air line
8 dowel pin
9 fitting bore
10 marking bore
11 heat-conducting body
12 calibration plate
13 hemispherical element
14 calibration dowel pin
14.1 longitudinal groove
14.2 threaded section
15 reference marking
16 shut-off valve
17 shut-off valve control unit
18 component holder
19 calibration platform
19.1 calibration pin
20 clamping bolt

1. Building platform system for installation in an additive manufacturing device, comprising a building platform (2) serving as a component carrier, characterized in that
the building platform system further comprises
a plate-shaped machine interface unit (1) that is designed as a base for the building platform (2), which can be releasably fastened in a positionally fixed manner on the machine interface unit (1), and
several base fastening units for the releasable fastening of the machine interface unit (1) in the additive manufacturing device,
wherein
each of the base fastening units for forming a screw connection with the additive manufacturing device comprises a connecting adapter (3) and a base screw (4) that is anchorable in a form-fitting manner in a screw head recess (3.1) provided laterally in the connecting adapter (3),
each of the connecting adapters (3) is insertable as an anchor on the screw head of the base screw (4) in a rotation-preventing manner into an adapter recess (1.1) which is adapted to the shape of the connecting adapter (3) and open towards the building platform (2) of the machine interface unit (1),
each of the connecting adapters (3) has a threaded bore (3.2) which is coaxially aligned with the base screw (4) anchored in the respective connecting adapter (3), wherein the threaded bore (3.2) on the connection adapter (3) is located on the side of the screw head opposite the thread of the base screw (4),
the machine interface unit (1) has a zero-point clamping system (6) for the releasable fastening of the building platform (2) to the machine interface unit (1), and
the machine interface unit (1) has, on its side facing the building platform (2), several fitting bores (9) for the insertion of dowel pins (8).

2. Building platform system according to claim 1, characterized in that the building platform (2) has fitting bores corresponding to the fitting bores (9) of the machine interface unit (1), into which dowel pins (8) can be inserted for mutual positional fixation of the building platform (2) and the machine interface unit (1).

3. Building platform system according to claim 1, characterized in that the plate-shaped machine interface unit (1) has recesses extending through in the thickness direction, which are filled in a form-fitting manner with heat-conducting bodies (11).

4. Building platform system according to claim 3, characterized in that the heat-conducting bodies (11) consist of copper or a copper alloy.

5. Building platform system according to claim 1, characterized in that the machine interface unit (1) and/or the building platform (2) has an RFID transponder for contactless data storage and data query of identification data, calibration data and/or manufacturing data.

6. Building platform system according to claim 1, characterized in that it comprises a calibration set for calibrating the machine interface unit (1), which is releasably fastened in the additive manufacturing device, wherein the calibration set comprises:
a calibration plate (12) that is releasably and covering attachable to the side of the machine interface unit (1) intended for fastening the building platform (2) for calibration, and
several calibration dowel pins (14), each having a reference marking (15), that can be releasably inserted into the fitting bores (9) of the machine interface unit (1) for calibration.

7. Building platform system according to claim 6, characterized in that the calibration set further comprises a hemispherical element (13) with a reference marking (15) which is releasably attachable to the zero-point clamping system (6) for calibration, wherein the calibration plate (12) has a recess for the hemispherical element (13) in the area of the zero-point clamping system (6).

8. Building platform system according to claim 1, characterized in that it a calibration set for calibrating the machine interface unit (1), which is releasably fastened in the additive manufacturing device, wherein the calibration set comprises:
a calibration platform (19) designed to correspond to the building platform (2) for releasably attachment to the machine interface unit (1),
a calibration plate (12) that can be releasably attached to the calibration platform (19) for calibration, and
several calibration pins (19.1), each with a reference marking (15), which are securely installed on the surface of the calibration platform (19) facing the calibration plate (12).

9. Building platform system according to claim 1, characterized in that the building platform (2) is a standard building platform (2.2) which can be releasably fastened in a positionally fixed manner by means of building platform screws (5) in the threaded bores (3.2) of the anchored connecting adapters (3).

10. Building platform system according to one of claims 1 claim 9, characterized in that the building platform (2) is a quick-change building platform (2.1) which can be releasably fastened in a positionally fixed manner on the machine interface unit (1) by means of the zero-point clamping system (6).

11. Building platform system according to claim 10, characterized in that the zero-point clamping system (6) is operated pneumatically by means of compressed air, wherein the zero-point clamping system (6) has a shut-off valve (16) connected to a shut-off valve control unit (17) for interrupting the supply of the compressed air.

12. Building platform system according to claim 1, characterized in that it further comprises at least one component holder (18) which is lockable on the building platform (2) and pivotable in its angular position.

13. Building platform system according to claim 1, characterized in that it further comprises at least one component holder (18) which is lockable on the building platform (2) and has an integral heating element.
